(19) United States
(12) Patent Application Publication
(10) Pub. No.: US 2022/0129871 A1
(43) Pub. Date: Apr. 28, 2022

(54) SYSTEM FOR MAPPING USER TRUST RELATIONSHIPS

(71) Applicant: Wells Fargo Bank, N.A., San Francisco, CA (US)

(72) Inventors: Douglas S. Rodgers, Mooresville, NC (US); Jonathan L. Gabel, Charlotte, NC (US); Nick A. Maiorana, Charlotte, NC (US); David H. Keene, Bessemer City, NC (US); Michael Joseph Pleasant, Charlotte, NC (US)

(21) Appl. No.: 15/134,180

(22) Filed: Apr. 20, 2016

(51) Int. Cl. G06Q 20/10; G06Q 20/40; G06Q 50/00

(52) U.S. Cl. CPC G06Q 20/108; G06Q 50/01; G06Q 20/4016

(57) ABSTRACT

Techniques are disclosed for receiving information describing a plurality of interpersonal relationships between users of a financial system, using this information to create a graph of nodes and edges describing the plurality of interpersonal relationships between the users, using the graph to determine that a first user of the financial system may pose a security risk, using the graph to determine users having relationships with the first user that may present a security risk, and performing an action to improve the security of the financial system.

### TECHNICAL FIELD

This disclosure generally relates to techniques for improving security of a financial system.

### BACKGROUND

Computing systems and databases are becoming increasingly popular as mechanisms by which customers access personal and business-related financial information at various financial institutions. As an example, online banking systems provide interactive interfaces through which customers may view financial information or perform various financial transactions. For example, a financial institution may provide services that allow customers to electronically deposit funds into an account, transfer funds between accounts, invest funds, and transact payments to other parties.

In mathematics and computer science, graph theory is the study of graphs, which are mathematical structures used to model pairwise relations between objects. A graph may include vertices, nodes, or points which are connected by edges, arcs, or lines. Graphs may be used to model many types of relations and processes in physical, biological, social and information systems. For example, graph theory may be used to represent groups of people with some pattern of contacts or interactions between them. Analysis of graphs may reveal statistical properties that characterize the structure of these networks and ways to measure them. For example, graph theory may allow one to create models of networks and predict behavior of entities within the networks based on measured structural properties and models. Some common applications include data aggregation and mining, network propagation modeling, network modeling and sampling, user attribute and behavior analysis, and social relationship analysis.

### SUMMARY

In general, the disclosure describes techniques for building a graph network describing the customers of a financial system and their potential security risk to the financial system. In some examples, the techniques include receiving information describing a plurality of interpersonal relationships between customers of a financial system. In some examples, a customer may provide information describing at least one interpersonal relationship of the customer via a game that the customer plays in exchange for a reward or coupon. The financial system may use the social information received from its customers to build a graph describing the plurality of interpersonal relationships between the customers. According to the techniques of the disclosure, a graph may be created and maintained that describes the interpersonal relationships of each of its customers. The graph may possess a plurality of nodes and a plurality of edges, where each node represents a customer, and each edge connecting two nodes represents a relationship between two corresponding customers. The financial institution may then use this graph to enhance security for its customers and to more quickly detect and react to fraudulent or suspicious activity.

For example, if a first customer of a financial institution is subject to fraudulent activity, then those customers related to the first customer (i.e., family relationships, coworkers, classmates, friends) may be at a higher risk of additional fraudulent activity than customers that have no relation to the first customer (i.e., strangers). This may be because compromised personal information of the first customer may be used to target related customers with a higher rate of success (e.g., so-called spear-phishing attacks), for example.

According to the techniques of the disclosure, the financial system may determine that a first customer of the financial system may pose a security risk to the financial system. For example, fraudulent activity may be detected within an account of the first customer. Using the graph of customer relationships, the financial system may determine which customers have relationships with the first customer by determining which nodes of the graph share an edge with a node of the graph representing the customer. The financial system may perform an action to improve the security of the system. For example, the financial system may perform fraud monitoring on the accounts of the first customer and the accounts of each customer having a relationship with the first customer.

In one example, this disclosure describes a method including: receiving, by one or more processors, information describing at least one interpersonal relationship between a first user of a financial system and a second user of the financial system; creating, by the one or more processors, a graph based at least in part on the received information, wherein the graph comprises a plurality of nodes and a plurality of edges, each node of the plurality of nodes representing a user of the financial system, and each edge of the plurality of edges connecting two nodes of the plurality of nodes and representing an interpersonal relationship between users of the financial system, and wherein a first node of the plurality of nodes represents the first user, a second node of the plurality of nodes represents the second user, and a first edge of the plurality of edges, connecting the first node to the second node, represents an interpersonal relationship between the first user and the second user; determining, by the one or more processors, that the first user presents a potential security risk to the financial system; in response to determining that the first user of the financial system presents a potential security risk to the financial system, determining, by the one or more processors, and based on the graph, that the second user presents a potential security risk to the financial system; and in response to determining, based on the graph, that the second user of the financial system presents a potential security risk to the financial system, performing, by the one or more processors, an action to address the potential security risk.

In another example, this disclosure describes a system including: a memory, and one or more processors in communication with the memory and configured to: receive information describing at least one interpersonal relationship between a first user of a financial system and a second user of the financial system; create a graph based at least in part on the received information, wherein the graph comprises a plurality of nodes and a plurality of edges, each node of the plurality of nodes representing a user of the financial system, and each edge of the plurality of edges connecting two nodes of the plurality of nodes and representing an interpersonal relationship between users of the financial system, and wherein a first node of the plurality of nodes represents the first user, a second node of the plurality of nodes represents the second user, and a first edge of the plurality of edges, connecting the first node to the second node, represents an interpersonal relationship between the first user and the second user; determine that the first user presents a potential security risk to the financial system; in response to determining that the first user of the financial system presents a potential security risk to the financial system, determine, based on the graph, that the second user presents a potential security risk to the financial system; and in response to determining, based on the graph, that the second user of the financial system presents a potential security risk to the financial system, perform an action to address the potential security risk.

In another example, this disclosure describes a computer-readable medium comprising instructions for causing at least one programmable processor to: receive information describing at least one interpersonal relationship between a first user of a financial system and a second user of the financial system; create a graph based at least in part on the received information, wherein the graph comprises a plurality of nodes and a plurality of edges, each node of the plurality of nodes representing a user of the financial system, and each edge of the plurality of edges connecting two nodes of the plurality of nodes and representing an interpersonal relationship between users of the financial system, and wherein a first node of the plurality of nodes represents the first user, a second node of the plurality of nodes represents the second user, and a first edge of the plurality of edges, connecting the first node to the second node, represents an interpersonal relationship between the first user and the second user; determine that the first user presents a potential security risk to the financial system; in response to determining that the first user of the financial system presents a potential security risk to the financial system, determine, based on the graph, that the second user presents a potential security risk to the financial system; and in response to determining, based on the graph, that the second user of the financial system presents a potential security risk to the financial system, perform an action to address the potential security risk.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example system that includes a financial system and a plurality of customers having one or more interpersonal relationships according to the techniques of the disclosure.

FIG. 2 is a block diagram illustrating an example financial system including a graph of relationships between its customers according to the techniques of the disclosure.

FIG. 3 is a block diagram illustrating a graph of relationships between customers of a financial system according to the techniques of the disclosure.

FIG. 4 is a flowchart illustrating an example operation of performing an action to improve the security of the financial system according to the techniques of the disclosure.

### DETAILED DESCRIPTION

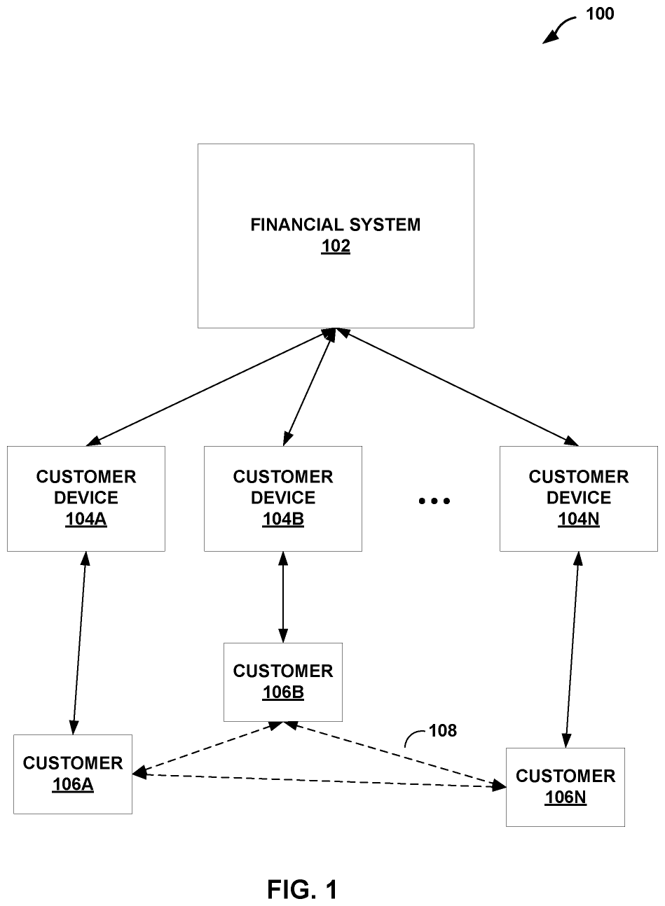

FIG. 1 is a block diagram illustrating an example system 100 that includes a financial system 102 and a plurality of customers 106A-106N (collectively, “customers 106”) having one or more interpersonal relationships 108 according to the techniques of the disclosure. In some examples, customers 106 may use one or more customer devices 104A-104N (collectively, “customer devices 104”), may interact with financial system 102 to conduct financial transactions and receive financial services.

Customer devices 104 may include, for example, desktop computers, laptops, workstations, mobile devices, personal digital assistants (PDAs), wireless devices, or other devices. Financial system 102 may comprise one or more servers or employee computer terminals, for example. Customer devices 104 may communicate with financial system 102 over a private network or a public network (not shown), such as the Internet. For example, the network may be an enterprise network, a campus network, a service provider network, a home network, a local area network (LAN), a virtual local area network (VLAN), virtual private network (VPN), or another autonomous system. In any of these examples, remotely located customer devices 104 and financial system 102 may exchange data via the network. Financial system 102 may also receive information describing one or more interpersonal relationships of customers 106 via customer devices 104. For example, financial system 102 may receive information provided by customers 106 via customer devices 104 in response to a request for such information by financial system 102. In one example, financial system 102 may receive the information from customer devices 104 in response to requests posed as part of a cybersecurity game being played by one or more of customers 106. Financial system 102 may use the information describing one or more interpersonal relationships of customers 106 to build and maintain a graph describing the one or more interpersonal relationships. Financial system 102 may perform graph analysis and data mining operations on the graph to determine relationships between customers 106. Financial system 102 may use this analysis to detect potential security risks to financial system 102 and customers 106. Financial system 102 may perform corrective actions to mitigate these detected security risks. In some examples, the corrective actions include monitoring one or more accounts associated with customers 106 or providing educational services to one or more customers 106. In other examples, the corrective actions include “freezing” one or more accounts associated with customers 106. Freezing an account prevents any transactions from occurring in the account. Typically, any open transactions are cancelled, and checks presented on a frozen account are not honored.

Accordingly, financial system 102 may build a graph of the relationships of its customers and use this information to improve the security of the financial system. Financial system 102 may, in some examples, identify one or more “risk groups” or areas of security vulnerability within the financial system and perform actions to mitigate that risk. For example, financial system 102 may rapidly detect fraudulent or suspicious activity occurring within the financial system and take countermeasures to prevent or stop such activity. Further, financial system 102 may identify customers posing a security risk to the financial system and provide them with a resource, such as risk insurance or education materials to strengthen their cybersecurity understanding, thereby increasing the overall security of financial system 102.

The architecture of system 100 illustrated in FIG. 1 is shown for purposes of example only. The techniques as set forth in this disclosure may be implemented in the example system 100 of FIG. 1, as well as other types of systems not described specifically herein. For example, “N,” as used to describe customers 106-106N and customer devices 104A-104N, may indicate any number of customers or customer devices.

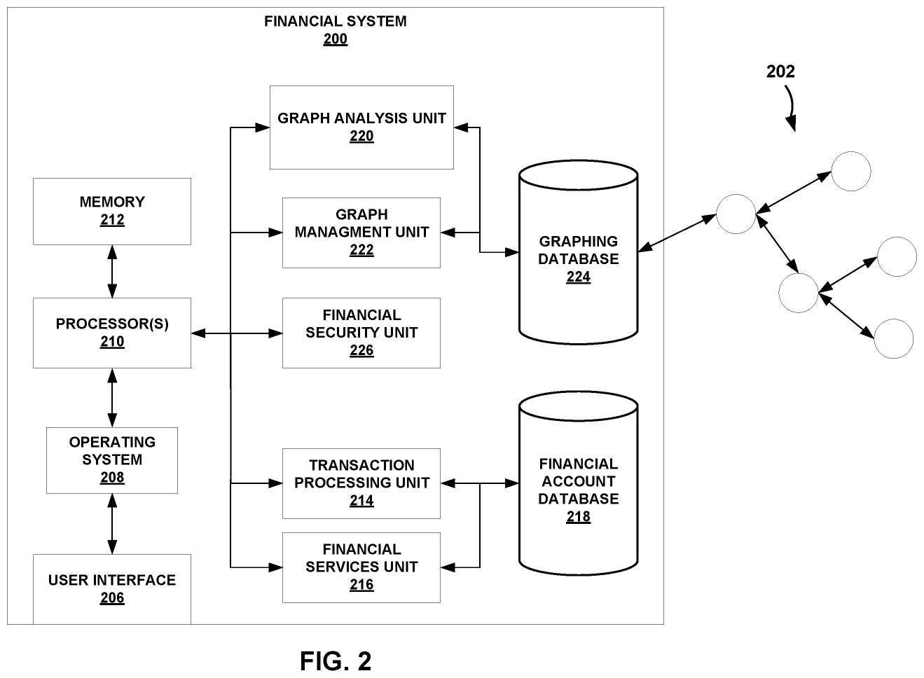

FIG. 2 is a block diagram illustrating an example financial system 200 including a graph 202 of relationships between its customers according to the techniques of the disclosure. In some examples, financial system 200 may operate substantially similar to financial system 102 of FIG. 1. In some examples, customers 106 may use customer devices 104 to interact with user interface 206 of financial system 200 to conduct financial transactions and receive financial services. Financial system 200 may include one or more processors 210 and a memory 212 that implement operating system 208 and execute the one or more financial transactions and services provided by financial system 200. Financial system 200 may include a transaction processing unit 214 and financial services unit 216 that communicate with financial account database 218 to perform one or more financial transactions and financial services for customers 106.

Financial system 200 may also receive information, via user interface 206, from customers 106 describing one or more interpersonal relationships of customers 106 via user interface 206. In one example, a customer 106 accesses financial system 200 to conduct a banking transaction. During the transaction, financial system 200 provides the customer 106 with an opportunity to play a cybersecurity game in exchange for a reward or financial incentive. In the course of playing the game, customer 106 provides information describing one or more interpersonal relationships between customers 106 and other customers of financial system 100. In some examples, the customer accesses financial system 200 via an ATM, an online banking service via a web browser interface, or a banking kiosk.

Graph management unit 222 may use the information received from customers 106 to build and maintain a graph 202 of customer relationships stored by graphing database 224. Graph analysis unit 220 may perform graph analysis and data mining operations on graph 202 to determine relationships between customers within financial system 200. Financial security unit 226 may use the analysis performed by graph analysis unit 220 to determine security risks to financial system 200. Financial security unit 226 may perform corrective actions to mitigate detected security risks, such as monitoring or freezing one or more accounts of financial account database 218 associated with one or more customers 106.

In some examples, processors 210 may be microprocessors, digital signal processors (DSPs), application specific integrated circuits (ASICs), field programmable gate arrays (FPGAs), or any other equivalent integrated or discrete logic circuitry, as well as any combinations of such components. Further, memory 212 may be random access memory (RAM), read only memory (ROM), programmable read only memory (PROM), erasable programmable read only memory (EPROM), electronically erasable programmable read only memory (EEPROM), flash memory, comprising executable instructions for causing the one or more processors to perform the actions attributed to them. Further, this memory may be implanted entirely in hardware, software, or a combination thereof.

In some examples, customers may access financial services provided by financial system 200 via user interface 206. Example user interfaces may include command line interfaces (“CLIs”), graphical user interfaces (“GUIs”), browser-based interfaces, mobile device application or “app” interfaces, and the like.

In some examples, processors 210 and memory 212 may implement operating system 208 and the other elements of financial system 200. Operating system 208 may provide management, scheduling, and control functions over the operation of the other elements of financial system 200. For example, operating system 208 may facilitate the communication of various elements illustrated in FIG. 2 between each other, such as graph analysis unit 220, graph management unit 222, financial security unit 226, transaction processing unit 214, and financial services unit 216, as well as allocate resources of processors 210 and memory 212 to these elements.

In some examples, financial services unit 216 may offer one or more financial services that customers 106 may perform on one or more financial accounts maintained by financial account database 218. For example, financial services unit 216 may include a bill pay service that allows a customer to pay bills, such as the customer's utility, electric, heating, rent, or other types of bills, through the online banking system. As a further example, financial services unit 216 may include a fund transfer service that allow the customer to transfer funds between different accounts that are either held internally by the financial institution, between accounts external to the financial system, or for person-to-person transactions. As a further example, financial services unit 216 may include a view balance service that allows the customer to quickly view a current balance in a given account, and a deposit service that allows the customer to deposit funds into a given account. As a further example, financial services unit 216 may include an online wire service that allows the customer to wire funds to domestic or international accounts at other banks. As a further example, financial services unit 216 may include a global remittance service that allows the customer to transfer funds in different currencies to individuals located in different countries. As a further example, financial services unit 216 may include a vendor payment service that allows the customer to pay invoices and debts to vendors in exchange for services rendered. As a further example, financial services unit 216 may include an employee payroll service that allows an employer to pay employees by transferring money from a payroll account to the employee's direct deposit account. As a further example, financial services unit 216 may include a brokerage service that allows a customer to purchase, sell, and manage investments and securities.

In some examples, transaction processing unit 214 may facilitate one or more transactions performed by customers 106 between a plurality of accounts managed by financial account database 218. For example, transaction processing unit 214 may allow a customer to transfer funds from a first account he holds with the financial institution to a second account he holds with the financial institution. As further examples, transaction processing unit 214 may allow a customer to electronically deposit or withdraw funds into an account, transfer funds to an individual, transfer funds to an account external to financial system 200, transfer funds into or out of a brokerage account, and transact payments to other parties.

Financial account database 218 may store and maintain information describing the financial accounts held by customers 106 within financial institution 200. In some examples, for each financial account, financial account database 218 may store information describing a unique identifier for the account, the owner of the account, the balance of the account, and the transaction history of the account. In some examples, financial account database 218 may be a database distributed across a network. In further examples, financial account database 218 may be a database external to financial system 200.

In some examples, user interface 206 may provide a cybersecurity game to customers 106. In the course of playing the cybersecurity game, customers 106 may provide information describing one or more interpersonal relationships between the customers of financial system 200. In some examples, customers 106 may identify other customers with whom they share relationships, such as family members, friends, coworkers, and classmates. In some examples, a customer may indicate his level of trust in another customer (e.g., how well the customer knows the identified person, and how trustworthy the customer feels the identified person is). In other examples, a customer may indicate his level of confidence in the cybersecurity or computer security knowledge of another customer. Financial system 200 may incentivize customers 106 to play the cybersecurity game. For example, financial system 200 may provide financial incentives or perks, such as reduced ATM fees, free checking, or other rewards to the customers that play the cybersecurity game.

User interface 206 may pass the received information describing at least one interpersonal relationship between customers and pass this information to graph management unit 222. Graph management unit 222 may use this information to build and maintain graph 202 of interpersonal relationships within graphing database 224. For example, each of customers 106 may be represented by a node within a graph, and each relationship between two customers may be represented by an edge connecting two nodes of the graph. In some examples, graph management unit 222 may use information received from customers 106 describing interpersonal relationship between customers 106 to add or remove nodes to the graph (representing customers 106) and to add or remove edges between two nodes of the graph (representing learnt relationships between customers 106). In some examples, graph management system 222 may store indications of the level of trust one customer has in another customer's cybersecurity ability within an edge representing the relationship between those two customers.

Graphing database 224 may provide storage for graph 202 of interpersonal relationships that is maintained by graph management unit 222. Graphing database 224 may organize stored information as a group of nodes, edges, and properties of the nodes and edges. In some examples, graphing database 224 may a non-relational database, and may store data according to a key-value store or document-oriented database structure. In some examples, graphing database 224 may be a single computing device with storage. In other examples, graphing database 224 may be implemented on one or more servers distributed across a network.

Graph analysis unit 220 may perform graph analysis and data-mining of graph 202 of interpersonal relationships to reveal statistical properties or relationships between customers 106 described by graph 202. For example, graph analysis unit 220 may identify networks of customers having relationships to a particular customer. As a further example, graph analysis unit 220 may determine networks of relationships between customers, or identify customers based on particular characteristics of the social networks they belong to. In one example, graph analysis unit 220 receives from financial security unit 226 an indication of a first customer posing a potential security risk to financial system 200. Graph analysis unit 220 determines the node of graph 202 associated with the first customer. Graph analysis unit 220 determines each customer having a relationship with the first customer by determining each node of graph 202 sharing an edge with the node associated with the first customer. Graph analysis unit 220 provides an indication of the customers having a relationship with the first customer back to financial security unit 226.

In another example, each edge of graph 202 indicating a relationship between two customers includes an associated indication of trust each customer has for the other. In this example, graph analysis unit 220 determines each customer having a relationship with the first customer by determining which customers have a particular level of trust with one another. For example, graph analysis unit 220 determines that a group of nodes having edges with low trust levels amongst one another indicate that the customers represented by the group of nodes are strangers to one another. In another example, graph analysis unit 220 determines that a group of nodes having edges with high trust levels amongst one another indicate that the customers represented by the group of nodes are familiar with one another, such as family, friends, coworkers, or neighbors.

In another example, each edge of graph 202 indicating a relationship between two customers includes a rating by each customer of the cybersecurity knowledge held by the other. In this example, graph analysis unit 220 determines a risk group by identifying a group of nodes having a particular net cybersecurity rating. For example, graph analysis unit 220 determines that a node of graph 202 that shares multiple edges with low cybersecurity ratings indicates that the customer represented by the node has low cybersecurity knowledge. Accordingly, graph analysis unit 220 identifies this customer, and customers related to this customer, as a risk group, and may send the risk group information to financial security unit 226.

Graph analysis 220 may create risk groups of different sizes and depths within graph 202 depending on the particular analysis performed. In one example, graph analysis unit 220 identifies the members of a risk group by receiving an indication of a first customer that presents a risk to financial network 200 and identifying each customer having a relationship with that customer. In this example, the risk group includes the first customer, represented by a first node of graph 202, and each customer represented by a node connected by an edge to the first node (e.g., one “hop” on graph 202 from the node associated with the first customer). In other examples, graph analysis unit 220 identifies the members of a risk group by identifying each customer two “hops” from the first customer (e.g., a friend of a friend), and so on. Graph analysis unit 220 may scale the size of the risk group in response to the threat to financial system 200 perceived by financial security unit 226. For example, if financial security unit 226 determines that the risk to financial system 200 is due to the lack of cyber security training of an individual, then graph analysis unit 220 creates a risk group including only that individual and the customers sharing an immediate relationship with the individual. On another example, if financial security unit 226 determines that the risk to financial system 200 is due to an individual operating in a suspected criminal fraud ring, then graph analysis unit 220 creates a risk group including customers two, four, or even more “hops” from the individual within graph 202 so as to group as many individuals as possible into the risk group to prevent harm to financial system 200 and the legitimate customers.

As one illustration, financial security unit 226 may use graph analysis unit 220 to identify “risk groups,” or areas of graph 202 that are characterized as having low levels of trust amongst customers, or low levels of confidence in the cybersecurity ability of customers. For example, a criminal perpetrating fraudulent or suspicious activity on financial system 200 may create a fraudulent user account so that they may conduct malicious activity on the financial system 200. This fraudulent user account may have no or very few actual relationships to other customers of financial system 200 because it is not a real human being with real relationships. Thus, financial security unit 226 identifies these types of users by detecting their lack of relationships with graph 202. Financial security unit 226 further identifies these users as members of “risk groups” and performs an action to improve security within the risk groups. For example, financial security unit 226 may identify the accounts of the suspicious customers as candidates for increased scrutiny, perform additional fraud monitoring on the user accounts, or freeze the assets of accounts.

In a further example, criminals may attempt to establish a plurality of fraudulent users having relationships with each other so that the artificial social network of the fraudulent users camouflages their malicious activity within financial system 200. Financial system 200 may identify one of these users as fraudulent (e.g., by account monitoring, detecting suspicious account activity, detecting fraudulent purchases, associating the account with stolen credit card numbers, etc.). Financial security unit 226 may use graph 202 to identify each (potentially artificial) user having a relationship with the detected fraudulent user so that the entire network of criminal users may be detected. In response to detecting this criminal ring, financial security unit 226 may identify the users as a risk group and perform an action relative to all members of the risk group to improve the security of the system. For example, financial security unit 226 may identify the accounts of the suspicious customers as candidates for increased scrutiny, perform additional fraud monitoring on the user accounts, or freeze access the assets of accounts.

In a further example, the financial system 200 builds graph 202 by collecting, via user interface 206, information from a first customer describing the relationship of the first customer to at least one other customer. The first customer may also provide a measure of his confidence in the computer security knowledge of the at least one other customer. Financial security unit 226 may use the measures of confidence gathered by a plurality of customers to identify those customers assessed by their peers as having poor computer security knowledge and determine these users to be a risk group. Financial security unit 226 uses this information to perform an action to improve the security of the system. For example, financial security unit 226 performs fraud monitoring on the accounts of the customers identified as having poor computer security knowledge. In a further example, financial security unit 226 offers a resource, such as education materials on cybersecurity, computer security training, or risk insurance, to the customers identified as having poor computer security knowledge.

As another example, if a customer falls victim to fraudulent activity, then customers having relationships with that customer may be more likely to be victims of fraudulent activity. For example, each member of the group may have used a credit card at a vendor or restaurant whose security was compromised. In another example, the victim may have one or more passwords compromised, allowing a criminal to attack the victim's friends and family via phishing or spear-phishing tactics. If financial security unit 226 detects that a first customer has undergone fraudulent activity, financial security unit 226 may use graph analysis unit 220 to identify customers socially connected to the first customer. In some examples, financial security unit 226 may classify these customers as members of a risk group and perform an action to improve security to all members of the risk group.

In some examples, financial security unit 226 may take one or more steps to improve the security within a risk group or within financial system 200. For example, financial security unit 226 may perform additional monitoring of account and customer activity within a risk group. In some examples, financial security unit 226 may freeze the assets and accounts of customers within a risk group. In some examples, financial security unit 226 may terminate the access credentials for customers within a risk group. In some examples, financial security unit 226 may cancel and reissue credit cards of customers within a risk group. In some examples, financial security unit 226 may apply a higher level of scrutiny to transactions performed within a risk group, require a waiting period before transactions can be completed, or require a customer to provide a secondary means of identification (e.g., by answering security questions, texting a code sent to the customer's mobile phone, etc.) to conduct a transaction. In some examples, financial security unit 226 may require customers within a risk group to change their passwords. In some examples, financial security unit 226 may offer a resource, such as education materials on cybersecurity or risk insurance, to customers within a risk group. In some examples, financial security unit 226 may provide notification to customers within a risk group that they may have been subjected to fraudulent activity.

Thus a financial system according to the techniques of the disclosure may build a graph of the relationships of its customers and use this information to improve the security of the financial system. Such a financial system as described herein may be used to identify “risk groups” or areas of security vulnerability within the financial system and perform actions to mitigate that risk. For example, such a financial system may be used to rapidly detect fraudulent or suspicious activity occurring within the financial system and take countermeasures to prevent or stop such activity. Further, such a financial system may be used to identify customers posing a security risk to the financial system and provide them with a resource, such as risk insurance or education materials, to strengthen their cybersecurity understanding, thereby increasing the overall security of the financial system.

The architecture of financial system 200 illustrated in FIG. 2 is shown for purposes of example only. The techniques as set forth in this disclosure may be implemented in the example financial system 200 of FIG. 2, as well as other types of systems not described specifically herein. In other examples, the elements of financial system 200 may be implemented in hardware, software, or a combination of both. In further examples, the elements of financial system 200 may be implemented in a single system or distributed across a network. Nothing in this disclosure should be construed so as to limit the techniques of this disclosure to the example architecture illustrated by FIG. 2.

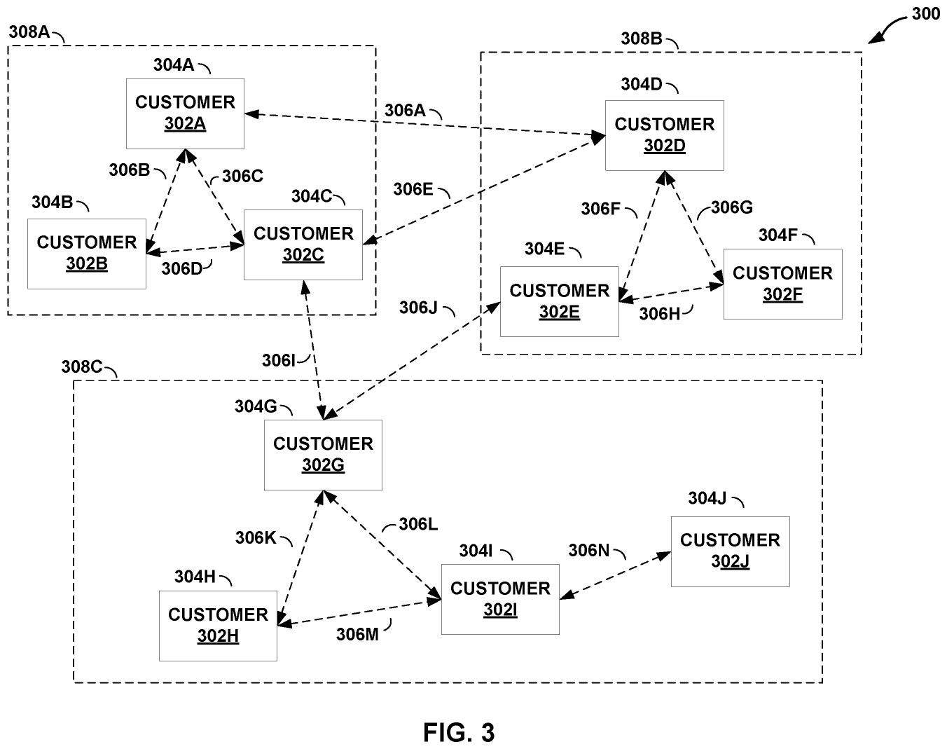

FIG. 3 is a block diagram illustrating a graph 300 of relationships between customers 106 of a financial system according to the techniques of the disclosure. Graph 300 of customer relationships may be substantially similar to graph 202 of customer relationships stored by graphing database 224 of FIG. 2, and is described with reference to the example of FIGS. 1-2. Graph 300 may include one or more nodes 304A-304J (collectively, “nodes 304”) which may represent customers 302A-302J (collectively, customers 302) of financial system 200. Graph 300 may also include one or more edges 306A-306N (collectively, “edges 306”). Each of edges 306 may connect two nodes of nodes 304 and may represent an interpersonal relationship between the two customers represented by the two nodes of nodes 304. The relationships of nodes 304 and edges 306 may be used to organize subgroups of customers 308A-308C (collectively, “subgroups 308”).

Each of nodes 304 may include information identifying one or more customers 302-320. In some examples, customers 302-320 may be identified by their names, social security numbers, account numbers, or some other identifier.

Each of edges 306 may indicate the relationship between two customers. For example, an edge may indicate that two customers are family members, coworkers, classmates, or friends. In some examples, an edge may indicate the nature of the relationship, such as that the two customers are brother/sister, mother/son, husband/wife, boss/employee, student/professor, and the like. In some examples, each of edges 306 may indicate a level of trust one customer has in another (e.g., how well the customer knows the identified person and how trustworthy the customer feels the identified person is). In other examples, each of edges 306 may indicate a level of confidence one customer has in the cybersecurity or computer security knowledge of another.

Graph analysis unit 220 may perform analysis of graph 300 that reveals interrelationships between subgroups of edges and nodes. For example, graph analysis unit 220 may perform analysis of graph 300 may reveal that customers 302A-302C belong to the same family (e.g., subgroup 308A), while customers 302D-302F work for the same company (e.g., subgroup 308B). Accordingly, graph analysis unit 220 may organize subgroups of edges and nodes into subgroups 308 which may indicate a relationship structures between multiple customers.

In some examples, graph analysis unit 220 may organize subgroups of edges and nodes according to an analysis of their security risk to financial system 200 to create “risk groups.” For example, graph analysis unit 220 may use information contained within each of edges 306 that describes a level of confidence one customer has in another, or an indication of the cybersecurity or computer security a customer possesses, to determine areas of graph 300 that have low levels of trust amongst users, or low levels of cybersecurity knowledge amongst users. Financial security unit 226 may identify these “risk groups” as areas posing a potential security risk to financial system 200 and perform actions to improve the security in these areas.

In some examples, financial system 200 may receive information from a first customer via user interface 206 describing his level of trust in a second customer with which he shares a relationship or an appraisal of the computer security knowledge of that customer (i.e., the “trust relationship” between two customers). In some examples, financial system 200 may provide a cybersecurity game to a first customer, receive this information as input from the customer through the course of playing the game. Graph management unit 222 may store this information as part of the relationship information defined by edges 306. For example, customer 302A may provide information to financial system 200 establishing that customer 302C is the father of customer 302A. Customer 302A may further provide information suggesting that his confidence in the security knowledge of customer 302C is very low.

As described above, financial security unit 226 may operate in conjunction with graph analysis unit 220 to determine which users have poor trust relationships (i.e., which users are consistently rated as having poor computer security knowledge or are rated as “not trusted” by their peers.). In the example above, if, in addition to customer 302A, customers 302B, 302D, and 302G each provide information suggesting that their trust relationship with customer 302C is very low, financial security unit 226 may identify customer 302C as a security risk.

If a customer, such as customer 302C, is identified as a security risk, financial security unit 226 may take a corrective action to improve the security of the network. For example, financial security unit 226 may perform fraudulent activity monitoring on the accounts of customer 302C, freeze the account assets of customer 302C, or provide a resource, such as cybersecurity training courses or offers for risk insurance, to customer 302C.

In some cases, those customers having a relationship with a customer determined to be a potential security risk may be potential security risks themselves. Accordingly, graph 300 may be used to identify those customers having a relationship with a customer determined to be a potential security risk so that an action to improve the security of the network may be performed. With reference to the above example, if financial security unit 226 determines that customer 302C is a potential security risk, it may operate in conjunction with graph analysis unit 220 to identify those customers having a relationship with customer 302C (i.e., customers 302A, 302B, 302D, and 302G. In some examples, financial security unit 226 may classify these customers as a “risk group” to financial system 200. Using the information obtained from graph 300, financial security unit 126 may perform an action on each of these accounts within the risk group to improve the security of the network. For example, financial security unit 226 may perform fraudulent activity monitoring on each of the accounts belonging to customers 302A, 302B, 302D, and 302G, freeze their account assets, or provide educational materials to them.

Thus financial system 200 implementing a graph 202 according to the techniques of the disclosure may perform analysis of graph 202 to improve the security of the financial system. Financial system 200 may use graph 202 to identify “risk groups” or areas of security vulnerability within the financial system and perform actions to mitigate that risk. For example, financial system 200 may use graph 202 to rapidly detect fraudulent or suspicious activity occurring within financial system 200 and take countermeasures to prevent or stop such activity. Further, financial system 200 may use such a graph to identify customers posing a security risk to financial system 200 and provide them with a resource, such as risk insurance or education materials to strengthen their cybersecurity understanding, thereby increasing the overall security of the financial system.

The architecture of graph 300 illustrated in FIG. 3 is shown for example purposes only. The techniques as set forth in this disclosure may be implemented in the example graph 300 of FIG. 3, as well as other types of graphs not described specifically herein. In other examples, the number of customers 302, nodes 304, edges 206, and subgroups 308 may vary in their number and relationship to each other. Nothing in this disclosure should be construed so as to limit the techniques of this disclosure to the example graph illustrated by FIG. 3.

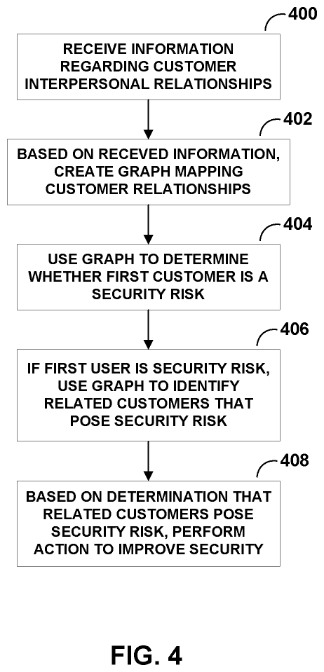

FIG. 4 is a flowchart illustrating an example operation of performing an action to improve the security of the financial system according to the techniques of the disclosure. The example operation of FIG. 4 may be implemented by a financial system such as financial system 200 of FIG. 2, and is described with reference to the example of FIGS. 1-2.

In some examples, financial system 200 may receive information from customer devices 104 regarding interpersonal relationships between a plurality of customers 106 via user interface 206 (400). In some examples, a customer may provide this information by playing a cybersecurity game in which the customer indicates a trust level of another user or rates the cybersecurity skill of another customer.

Graph management unit 222 may receive this information describing interpersonal relationships between customers 106 and use this information to build and maintain graph 202 stored within graphing database 224 (402). As described above, graph 202 may be comprised of a plurality of nodes and a plurality of edges connecting the plurality of nodes. Graph management unit 222 may organize graph 202 such that each node of graph 202 corresponds to a customer of financial system 200 and each edge corresponds between two nodes indicates a relationship between the two customers. In some examples, each edge may store the nature of the relationship, indicate the level of trust each customer has for the other, or indicate a rating by one customer of the cybersecurity knowledge of another customer.

Graph analysis unit 220 may perform statistical and data mining operations on graph 202 to discover networks of customer relationships. Financial security unit 226 may analyze these networks of relationships to determine whether a first customer is a potential security risk to financial system 200 (404). For example, financial security unit 226 may determine that a first customer has a low level of trust or a low level of cybersecurity knowledge, as indicated by ratings of the first customer by other customers of financial system 200. Once financial security unit 226 has determined that the first customer is a potential security risk, financial security unit 226 may use graph analysis unit 220 to identify all customers that are related to the first customer within graph 202 that pose a potential risk to financial system 200 (406).

Financial security unit 226 may identify this set (e.g., the first customer and related customers) as a “risk group” to financial system 200. Once financial security unit 226 has detected such a risk group, it may perform an action to improve security within financial system 200 (408). For example, financial security unit 226 may perform monitoring of accounts belonging to customers within the risk group, freeze the assets belonging to customers within the risk group, or offer a resource, such as cybersecurity training or risk insurance, to customers within the risk group.

The example operation illustrated in FIG. 4 is shown for example purposes only. The techniques as set forth in this disclosure may be implemented according to the example operation of FIG. 4, as well as other operations not described specifically herein. Nothing in this disclosure should be construed so as to limit the techniques of this disclosure to the example operation illustrated by FIG. 4.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

1. A method comprising:
receiving, by one or more first computing devices comprising one or more processors operatively coupled to a memory, a first input specifying a plurality of users of a financial system and a plurality of interpersonal relationships between the plurality of users of the financial system, the plurality of users including a first user;
building, by the one or more first computing devices based on the first input, a graph data structure configured to store information regarding the plurality of users and the plurality of interpersonal relationships between the plurality of users, wherein the graph data structure stores the first input as a plurality of nodes and a plurality of edges, each node of the plurality of nodes representing a user of the plurality of users of the financial system, and each edge of the plurality of edges representing an interpersonal relationship of the plurality of interpersonal relationships between at least two users of the plurality of users of the financial system;
storing, by the one or more first computing devices and within each edge of the plurality of edges of the graph data structure, a rating indicative of a trust relationship between the at least two users of the plurality of users;
receiving, by one or more second computing devices, a second input specifying that the first user presents a security risk to the financial system;
in response to receiving an indication from the one or more second computing devices that the first user of the financial system presents the security risk to the financial system, analyzing, by one or more third computing devices, the graph data structure stored by the one or more first computing devices, wherein analyzing the graph data structure includes:
identifying a first node of the graph data structure representative of the first user, and
identifying a plurality of second nodes of the graph data structure that share edges with the first node as members of a risk group to which the first user belongs based on the ratings stored within the edges, wherein each second node of the plurality of second nodes is representative of a second user of a plurality of second users, and wherein
each rating, stored within each edge between the first node and each respective second node, is indicative of the trust relationship between the first user and the respective second user of the plurality of second users; and
in response to receiving an indication from the one or more third computing devices that the first user and the plurality of second users are members of the risk group that presents a potential security risk to the financial system,
suspending, by the one or more second computing devices, activity on one or more accounts of each user that is a member of the risk group, including the first user and the plurality of second users.

2. (canceled)

3. The method of claim 1,
wherein receiving the first input, by the one or more first computing devices, specifying the plurality of interpersonal relationships between the plurality of users of the financial system comprises receiving, by the one or more first computing devices and for each edge of the plurality of edges of the graph data structure, the rating indicative of the trust relationship between the at least two users of the plurality of users, and
wherein receiving, by the one or more second computing devices, the second input specifying that the first user presents a security risk to the financial system comprises determining, by the one or more third computing devices, that the first user of the financial system presents the security risk to the financial system based on one or more ratings, stored within one or more edges of the graph data structure, that are indicative of the trust relationship between the first user and one or more other users of the plurality of users of the financial system.

4. The method of claim 1, further comprising, in response to receiving an indication from the one or more third computing devices that the first user and the plurality of second users are members of the risk group that presents the potential security risk to the financial system, outputting, by the one or more second computing devices for display to a computing device of an administrator of the financial system, an indication that the one or more accounts of the first user and the plurality of second users present the potential security risk to the financial system.

5. The method of claim 1, wherein suspending activity on the one or more accounts of the first user and the plurality of second users comprises, for each user:
monitoring the activity on the one or more accounts of the user;
identifying at least one indication of fraudulent activity on at least one account of the one or more accounts of the user; and
suspending activity on the one or more accounts of the user in response to the at least one indication of fraudulent activity.

6. The method of claim 1, further comprising, in response to receiving an indication from the one or more third computing devices that the first user and the plurality of second users are members of the risk group that presents the potential security risk to the financial system, outputting, by the one or more second computing devices for display, an educational resource to a user device of at least one second user of the plurality of second users.

7. (canceled)

8. The method of claim 1, wherein identifying the plurality of second nodes of the graph data structure comprises, for each second node of the plurality of second nodes:
identifying, by the one or more third computing devices, a second node of the plurality of nodes of the graph data structure, stored by the one or more first computing devices, that represents a second user;
determining that an edge of the plurality of edges of the graph data structure is shared between the first node and the second node; and
identifying that the edge shared between the first node and the second node is representative of the interpersonal relationship between the first user and the at least one second user.

9. The method of claim 8, wherein storing, within each edge of the plurality of edges of the graph data structure, the rating indicative of the trust relationship between the at least two users further comprises storing the rating indicative of the trust relationship between the first user and the second user within the edge shared between the first node and the second node, wherein the rating indicative of the trust relationship between the first user and the second user is based on one or more of a trust level that the second user associates with the first user or a cybersecurity skill level that the second user associates with the first user.

10. A system comprising:
one or more first computing devices comprising a memory, and one or more processors in communication with the memory wherein the one or more processors of the one or more first computing devices are configured to:
receive a first input specifying a plurality of users of a financial system and a plurality of interpersonal relationships between the plurality of users of the financial system, the plurality of users including a first user;
build, based on the first input, a graph data structure configured to store information regarding the plurality of users and the plurality of interpersonal relationships between the plurality of users, wherein the graph data structure stores the first input as a plurality of nodes and a plurality of edges, each node of the plurality of nodes representing a user of the plurality of users of the financial system, and each edge of the plurality of edges representing an interpersonal relationship of the plurality of interpersonal relationships between at least two users of the plurality of users of the financial system; and
store, within each edge of the plurality of edges of the graph data structure, a rating indicative of a trust relationship between the at least two users of the plurality of users;
one or more second computing devices comprising a memory, and one or more processors in communication with the memory, wherein the one or more processors of the one or more second computing devices are configured to receive a second input specifying that the first user presents a security risk to the financial system; and
one or more third computing devices comprising a memory, and one or more processors in communication with the memory, wherein the one or more processors of the one or more second computing devices are configured to:
in response to receiving an indication from the one or more second computing devices that the first user of the financial system presents the security risk to the financial system, analyze the graph data structure, stored by the one or more first computing devices, to:
identify a first node of the graph data structure representative of the first user, and
identify a plurality of second nodes of the graph data structure that share edges with the first node as members of a risk group to which the first user belongs based on the ratings stored within the edges, wherein each second node of the plurality of second nodes is representative of a second user of a plurality of second users, and wherein
each rating, stored within each edge between the first node and each respective second node, is indicative of the trust relationship between the first user and the respective second user of the plurality of second users,
wherein, in response to receiving an indication from the one or more third computing devices that the first user and the plurality of second users are members of the risk group that presents a potential security risk to the financial system,
the one or more processors of the one or more second computing devices are configured to suspend activity on one or more accounts of each user that is a member of the risk group, including the first user and the plurality of second users.

11-12. (canceled)

13. The system of claim 10, wherein , the one or more processors of the one or more second computing devices are further configured to, in response to receiving an indication from the one or more third computing devices that the first user and the plurality of second users are members of the risk group that presents the potential security risk to the financial system, output for display to a computing device of an administrator of the financial system, an indication that the one or more accounts of the first user and the plurality of second users present the potential security risk to the financial system.

14. The system of claim 10, wherein to suspend activity on the one or more accounts of the first user and the plurality of second users, the one or more processors of the one or more second computing devices are further configured to, for each user:
monitor the activity on the one or more accounts of the user;
identify at least one indication of fraudulent activity on at least one account of the one or more accounts of the user; and
suspend activity on the one or more accounts of the user in response to the at least one indication of fraudulent activity.

15. The system of claim 10, wherein the one or more processors of the one or more second computing devices are further configured to, in response to receiving an indication from the one or more third computing devices that the first user and the plurality of second users are members of the risk group that presents the potential security risk to the financial system, output, for display, an educational resource to a user device of at least one second user of the plurality of second users.

16. (canceled)

17. The system of claim 10, wherein to identify the plurality of second nodes of the graph data structure, the one or more processors of the one or more third computing devices are further configured to, for each second node of the plurality of second nodes:
identify a second node of the plurality of nodes of the graph data structure, stored by the one or more first computing devices, that represents a second user;
determine that an edge of the plurality of edges of the graph data structure is shared between the first node and the second node; and
identify that the edge shared between the first node and the second node is representative of the interpersonal relationship between the first user and the at least one second user.

18. The system of claim 17, wherein to store, within each edge of the plurality of edges of the graph data structure, the rating indicative of the trust relationship between the at least two users, the one or more processors of the one or more first computing devices are further configured to store the rating indicative of the trust relationship between the first user and the second user within the edge shared between the first node and the second node,
wherein the rating indicative of the trust relationship between the first user and the second user is based on one or more of a trust level that the second user associates with the first user or a cybersecurity skill level that the second user associates with the first user.

19. A computer-readable medium comprising:
instructions for causing at least one programmable processor of a first computing device to:
receive a first input specifying a plurality of users of a financial system and a plurality of interpersonal relationships between the plurality of users of the financial system, the plurality of users including a first user;
build, based on the first input, a graph data structure configured to store information regarding the plurality of users and the plurality of interpersonal relationships between the plurality of users, wherein the graph data structure stores the first input as a plurality of nodes and a plurality of edges, each node of the plurality of nodes representing a user of the plurality of users of the financial system, and each edge of the plurality of edges representing an interpersonal relationship of the plurality of interpersonal relationships between at least two users of the plurality of users of the financial system; and
store, within each edge of the plurality of edges of the graph data structure, a rating indicative of a trust relationship between the at least two users of the plurality of users;
instructions for causing at least one programmable processor of a second computing device to receive a second input specifying that the first user presents a security risk to the financial system; and
instructions for causing at least one programmable processor of a third computing device to:
in response to receiving an indication from the second computing device that the first user of the financial system presents the security risk to the financial system, analyze the graph data structure, stored by the first computing device, to:
identify a first node of the graph data structure representative of the first user, and
identify a plurality of second nodes of the graph data structure that share edges with the first node as members of a risk group to which the first user belongs based on the ratings stored within the edges, wherein each second node of the plurality of second nodes is representative of a second user of a plurality of second users, and wherein
each rating, stored within the each edge between the first node and each respective second node, is indicative of the trust relationship between the first user and the respective second user of the plurality of second users,
wherein the instructions further cause the at least one programmable processor of the second computing device to, in response to receiving an indication from the one or more third computing devices that the first user and the plurality of second users are members of the risk group that presents a potential security risk to the financial system,
suspend activity on one or more accounts of each user that is a member of the risk group, including the first user and the plurality of second users.

20. The computer-readable medium of claim 19,
wherein to store, within each edge of the plurality of edges of the graph data structure, the rating indicative of the trust relationship between the at least two users, the instructions further cause the at least one programmable processor of the first computing device to, for each second node of the plurality of second nodes, store the rating indicative of the trust relationship between the first user and the second user within the edge shared between the first node and the second node,
wherein the rating indicative of the trust relationship between the first user and the second user is based on one or more of a trust level that the second user associates with the first user or a cybersecurity skill level that the second user associates with the first user.

21. The method of claim 1, further comprising:
receiving, by the one or more first computing devices, a third input specifying at least a third user and one or more interpersonal relationships between the third user and one or more other users of the plurality of users of the financial system;
modifying, by the one or more first computing devices, the graph data structure by adding at least one node to the plurality of nodes of the graph data structure and one or more edges to the plurality of edges of the graph data structure or removing the at least one node from the plurality of nodes of the graph data structure and the one or more edges from the plurality of edges of the graph data structure, wherein the at least one node represents the third user and the one or more edges represent the one or more interpersonal relationships between the third user and the one or more other users of the plurality of users of the financial system; and
storing, by the one or more first computing devices and within the one or more edges of modified graph data structure, ratings indicative of trust relationships between the third user and the one or more other users of the plurality of users.

22. The method of claim 1, wherein receiving the first input specifying the plurality of users of the financial system and the plurality of interpersonal relationships between the plurality of users of the financial system comprises:
receiving the first input from a user device of a user of the plurality of users of the financial system; and
in response to receiving the first input, reducing an ATM fee charged to the user.

23. The system of claim 10, wherein to receive the first input specifying the plurality of users of the financial system and the plurality of interpersonal relationships between the plurality of users of the financial system, the one or more first computing devices are further configured to:
receive the first input from a user device of a user of the plurality of users of the financial system; and in response to receiving the first input, reduce an ATM fee charged to the user.
